(19) United States
(12) Patent Application Publication
(10) Pub. No.: US 2017/0278077 A1
(43) Pub. Date: Sep. 28, 2017

(54) INPUT ASSISTANCE METHOD, COMPUTER-READABLE RECORDING MEDIUM, AND INPUT ASSISTANCE DEVICE

(71) Applicants: FUJITSU LIMITED, Kawasaki-shi (JP); FUJITSU FSAS INC., Kawasaki-shi (JP)

(72) Inventors: Kenzo Watanabe, Yokohama (JP); Taiji Uchida, Kawasaki (JP); Yoshihito Nakamae, Kawasaki (JP); Takayoshi Watanabe, Yokohama (JP); Taihei Ishikuro, Yokohama (JP)

(73) Assignees: FUJITSU LIMITED, Kawasaki-shi (JP); FUJITSU FSAS INC., Kawasaki-shi (JP)

(21) Appl. No.: 15/457,103

(22) Filed: Mar. 13, 2017

(30) Foreign Application Priority Data
Mar. 23, 2016 (JP) 2016-059166

(51) Int. Cl. G06Q 10/00; G06F 3/0482

(52) U.S. Cl. CPC G06Q 10/20; G06F 3/0482

(57) ABSTRACT

An input assistance device includes a database that stores an incident case including a plurality of items in operation management. Then, the input assistance device receives an input to a specific item included in the plurality of items. Then, the input assistance device retrieves the incident case corresponding to the input in an extended range according to the specific item in response to the received input.

### CROSS-REFERENCE TO RELATED APPLICATION

This application is based upon and claims the benefit of priority of the prior Japanese Patent Application No. 2016-059166, filed on Mar. 23, 2016, the entire contents of which are incorporated herein by reference.

### FIELD

The embodiments discussed herein are related to an input assistance method, a computer-readable recording medium, and an input assistance device.

### BACKGROUND

In operation management of an information system, an inquiry from a user regarding a provided service is treated in management units called incidents, and a provisional response to the inquiry is performed. To be specific, a person in charge at the service desk registers the incident to the management system, upon receiving the inquiry from the user, and performs management and response in units of registered incident. When the person in charge at the service desk registers the incident, the response to the inquiry of the user is started. Further, with the incident registration, a notification of start of response (first call back) is provided to the user who had made the inquiry.

The registration of the incident is a starting-point process of incident management, and therefore the person in charge at the service desk needs to perform input processing for the registration of the incident promptly with appropriate content. In addition, information to be registered as the incident may include detailed description of inquiry content and response content, and some information takes time to create from scratch. Recently, a technology to display information of an incident input in the past item by item, and reflect input content of a newly input incident on the display is known.

Patent Literature 1: International Publication Pamphlet No. WO 2009/054215

In recent years, retrieval of incidents including most recently accumulated incidents and having items similar to an item to be retrieved becomes possible by use of a retrieval server such as Elasticsearch (registered trademark) based on Apache Lucene (registered trademark).

In a case where a most recently registered case is included in an object to be retrieved, and the incident registration is speeded up using a retrieval server capable of similarity retrieval, both a case where retrieval is desired to be performed expanding input content of past incidents and a case where only incidents exactly matched with input content are desired to be retrieved exist. However, the above-technology simply displays the input content of the past incidents only, and does not improve efficiency of registration like above.

### SUMMARY

According to an aspect of an embodiment, an input assistance method includes receiving, in an incident case including a plurality of items in operation management, an input to a specific item included in the plurality of items, using a processor; and retrieving the incident case corresponding to the input in an extended range according to the specific item in response the received input, using the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an example of an overall configuration of a system according to a first embodiment;

FIG. 2 is a diagram for describing registration and retrieval of an incident;

FIG. 3 is a functional block diagram illustrating a functional configuration of the system according to the first embodiment;

FIG. 4 is a diagram illustrating an example of an incident registration screen;

FIG. 5 is a diagram illustrating an example of a screen of incident retrieval results;

FIG. 6 is a diagram illustrating an example of a screen of modal display;

FIG. 7 is a diagram illustrating an example of an operation at the time of a left click;

FIG. 8 is a diagram illustrating an example of an operation at the time of a right click;

FIG. 9 is a diagram illustrating an example of information stored in an incident DB;

FIG. 10 is a diagram illustrating an example of information stored in a retrieval setting DB;

FIG. 11 is a diagram for describing a click operation;

FIG. 12 is a diagram for describing execution trigger of retrieval processing;

FIG. 13 is a flowchart illustrating a flow of the retrieval processing of a terminal device;

FIG. 14 is a flowchart illustrating a flow of the retrieval processing of an incident DB server;

FIG. 15 is a diagram for describing a retrieval range; and

FIG. 16 is a diagram for describing an example of a hardware configuration.

### DESCRIPTION OF EMBODIMENTS

Hereinafter, embodiments of an input assistance method, an input assistance program, and an input assistance device disclosed by the present application will be described in detail on the basis of the drawings. Note that the present invention is not limited by the embodiments.

### [a] First Embodiment

Overall Configuration

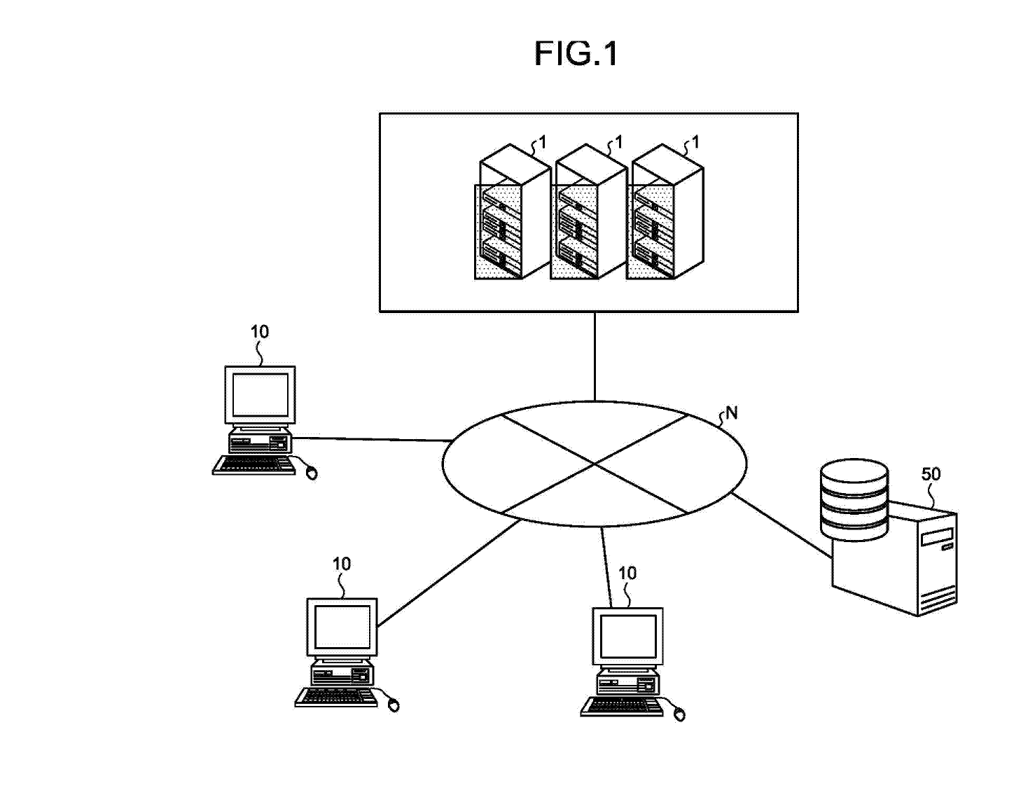

FIG. 1 is a diagram for describing an example of an overall configuration of a system according to a first embodiment. As illustrated in FIG. 1, this system is an incident management system including at least one service providing server 1 that provides customers with various services, a terminal device 10 used by a manager who manages the various services, and an incident DB server 50 that stores an incident case (in the present embodiment, may be simply described as “incident”).

The incident management system illustrated in FIG. 1 provides an incident retrieval function and a registration function for the terminal device 10 by mounting a retrieval engine having a similarity retrieval function such as Elasticsearch (registered trademark) based on Apache Lucene (registered trademark). Note that the devices illustrated in FIG. 1 are connected with one another in a communicative manner by a network N such as the Internet.

The service providing server 1 is an example of a server device that provides the customers with various services, and failure management software is resident therein. The failure management software monitors a failure on a regular basis, and displays the failure on a predetermined display device or displays the failure on the terminal device 10 that manages the service in which the failure has occurred, when detecting the failure.

The terminal device 10 is an example of a computer that monitors the failure of the service providing server 1. When there is an inquiry from the customer or the failure is detected in the system, the terminal device 10 registers an incident regarding a response to the inquiry or the failure to the incident DB server 50. Further, the terminal device 10 retrieves an appropriate incident from the incident DB server 50 in order to retrieve a similar failure, or a response to the similar failure, when a failure has occurred.

The incident DB server 50 is a server device that manages the incident occurring in the service providing server 1, and provides the retrieval engine having the similarity retrieval function. The incident DB server 50 registers an input incident to the DB upon receiving a registration request of the incident from the terminal device 10, and retrieves the appropriate incident from the DB and replies to the terminal device 10 upon receiving a retrieval request of the incident from the terminal device 10. Further, basically, the incident registered to the incident DB server 50 is not able to be deleted once registered unless otherwise deleted by a manager of the incident DB server 50. Therefore, the incident is registered at all times.

Description of Registration and Retrieval

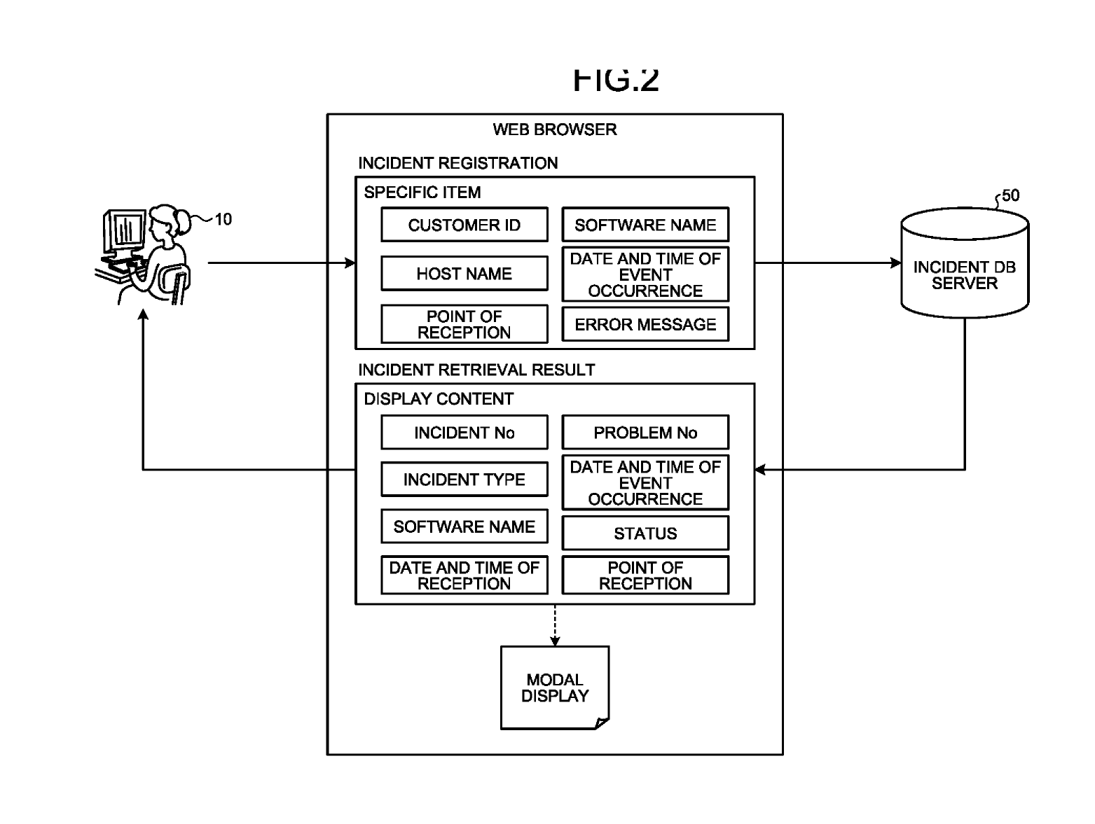

Next, processing of retrieving or registering the incident, using the terminal device 10, will be described. FIG. 2 is a diagram for describing registration and retrieval of the incident. As illustrated in FIG. 2, the terminal device 10 access the DB of the incident DB server 50, and executes retrieval and registration of the incident, using a Web browser in which an execution environment of JavaScript (registered trademark) (which may be simply described as “script” in the present embodiment) is mounted.

For example, when registering the incident, the terminal device 10 access the incident DB server 50, using the Web browser, and displays an incident registration screen as a top screen. Then, the terminal device 10 receives inputs of specific items including “a customer ID, a software name, a host name, date and time of occurrence of event, a point of reception, and an error message” that identify the incident on the incident registration screen from the manager. Then, a registration query is issued from the terminal device 10 to the incident DB server 50, and the incident DB server 50 executes the registration query, thereby to register the input incident to the DB.

Further, when retrieving the incident, the terminal device 10 access the incident DB server 50, using the Web browser, and displays the incident registration screen, similarly to the registration. Then, the terminal device 10 receives an input of a keyword on the incident registration screen from the manager. Then, the terminal device 10 issues a retrieval query to the incident DB server 50, and the incident DB server 50 executes the retrieval query to retrieve the appropriate incident from the DB. After that, when the incident DB server 50 replies with retrieval results, the terminal device 10 displays the retrieval results on the Web browser.

Further, the terminal device 10 displays, on a modal window (which may be simply described as “modal” in the present embodiment), a retrieval result selected by mouse-over from the plurality of retrieval results displayed on the Web browser. Then, the terminal device 10 left-clicks or right-clicks the retrieval result displayed on the modal, thereby to execute duplication and paste of the retrieval result of the incident to the items on the incident registration screen.

In such a system, in retrieving an incident case including a plurality of items in operation management, the incident DB server 50 retrieves, in response to an input to a specific item included in the plurality of items, an incident case corresponding to the input in an extended range according to the specific item.

For example, when the incident DB server 50 receives the retrieval query including an “item name: character string (keyword)” from the terminal device 10, the incident DB server 50 identifies a retrieval condition corresponding to the “item name”, of retrieval conditions determined in advance. Then, the incident DB server 50 executes the retrieval processing, using the “character string” as the keyword, according to the identified retrieval condition, and replies to the terminal device 10 with a retrieval result.

Therefore, a user such as a manager can refer to the retrieval result in the condition according to the item name to which the keyword is input, even if the user retrieves a registered similar incident at the time of registration of an incident. As a result, even if both an inputting item and a retrieval item are used, a retrieval result used for reference can be displayed even if input work proceeds.

Functional Configuration

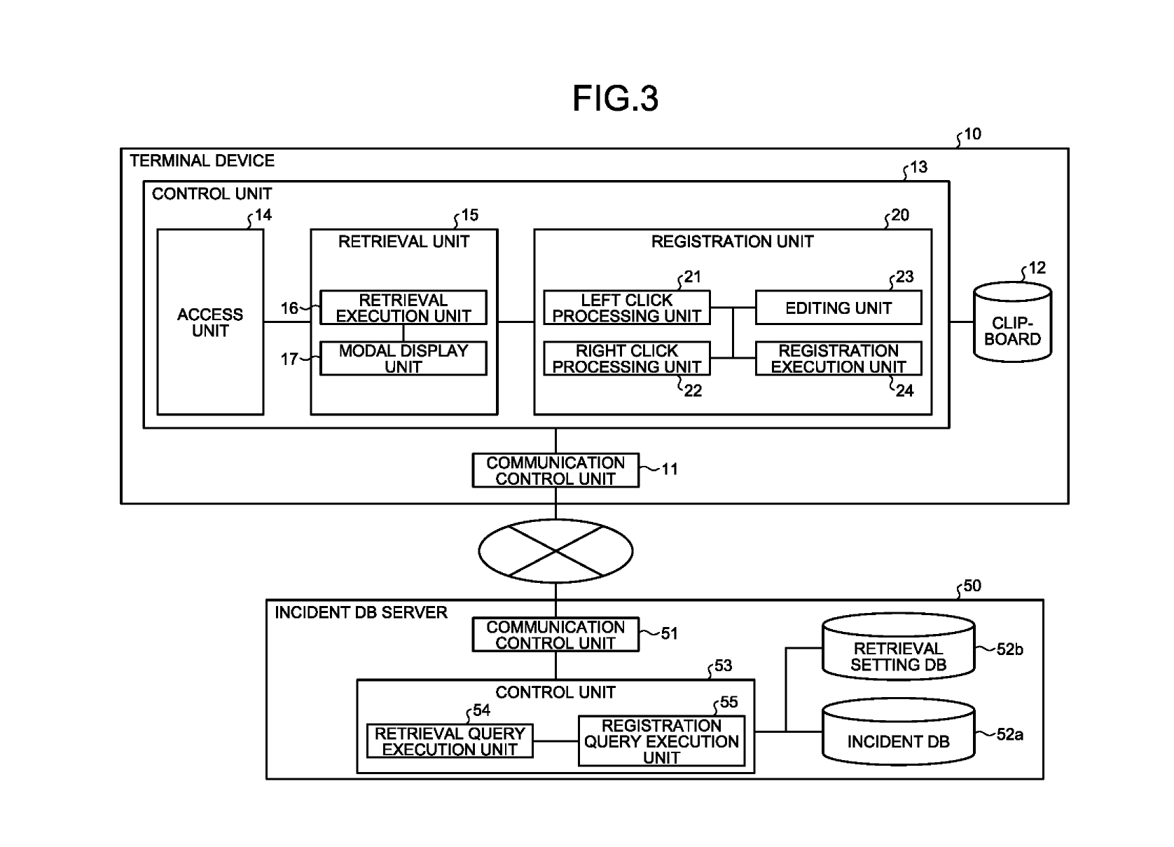

FIG. 3 is a functional block diagram illustrating a functional configuration of the system according to the first embodiment. Here, the terminal device 10 and the incident DB server 50 will be described.

Functional Configuration of Terminal Device 10

As illustrated in FIG. 3, the terminal device 10 includes a communication control unit 11, a clipboard 12, and a control unit 13.

The communication control unit 11 is a processing unit that controls communication between the own device and other devices including the incident DB server 50 and the like, and is, for example, a network interface card. For example, the communication control unit 11 executes control regarding the Web browser between the own device and the incident DB server 50, and receives a failure notification and the like from the service providing server 1. Further, the communication control unit 11 transmits the retrieval query, the registration query, and the like to the incident DB server 50.

The clipboard 12 is a temporary area provided by the operating system of the terminal device 10. The clipboard 12 is overwritten with a character string processed by a left click processing unit 21 described below.

The control unit 13 is a processing unit that controls processing of the entire terminal device 10, and is, for example, a processor. The control unit 13 includes an access unit 14, a retrieval unit 15, and a registration unit 20. Note that the access unit 14, the retrieval unit 15, and the registration unit 20 are examples of electronic circuits included in the processor, or examples of processes executed by the processor.

The access unit 14 is a processing unit that executes a Web access, using the Web browser in which the execution environment of the script is mounted. For example, when the Web browser is started by the manager, the access unit 14 accesses the incident DB server 50, and displays the incident registration screen as a top page. After that, the access unit 14 establishes communication, using the Web browser, and executes display of information, and the like.

The retrieval unit 15 is a processing unit that displays the incident registration screen, using the Web browser, and retrieves the incident to be registered to the incident DB server 50. The retrieval unit 15 includes a retrieval execution unit 16 and a modal display unit 17.

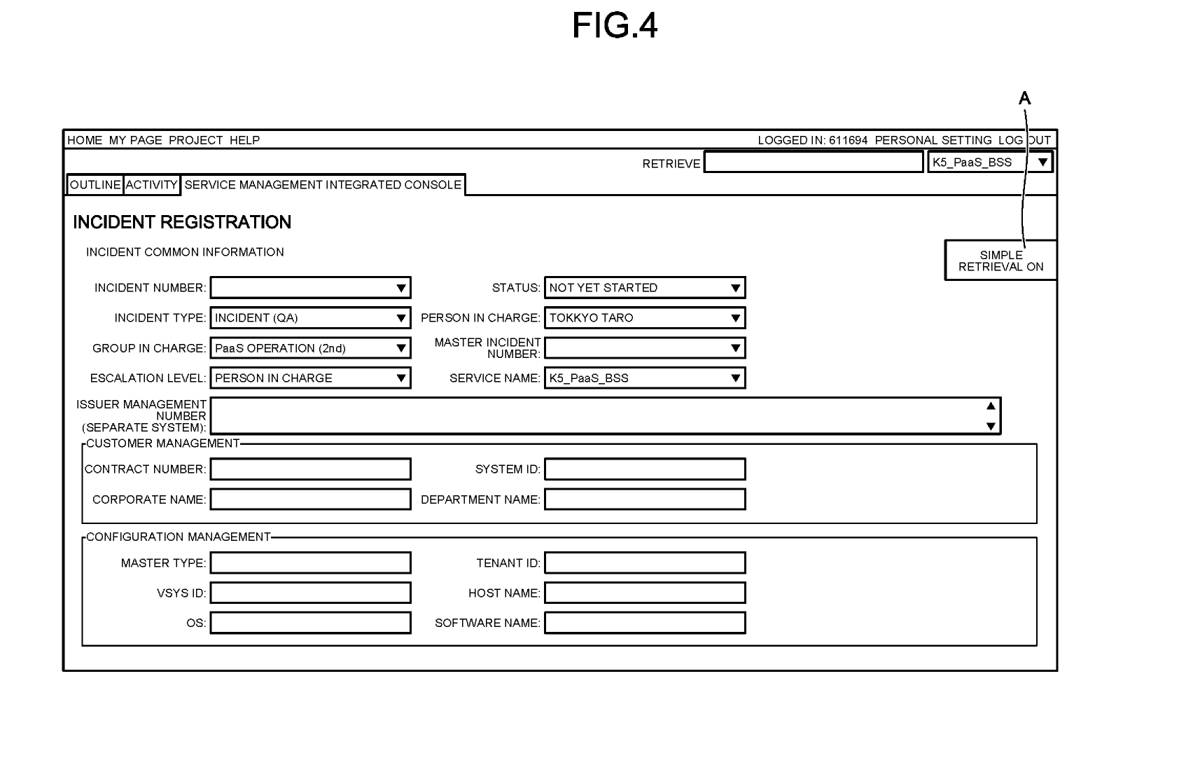

The retrieval execution unit 16 is a processing unit that detects the character string input on the incident registration screen. FIG. 4 is a diagram illustrating an example of the incident registration screen. As illustrated in FIG. 4, the incident registration screen includes an icon A of simple retrieval and incident common information. The icon A of simple retrieval allows switching of ON/OFF of the simple retrieval by being clicked. In a case of ON display, the incident retrieval function is effective in ON display, and the incident retrieval function is ineffective in OFF display.

The incident common information includes an incident number, a status, an incident type, a name of a person in charge, a group in charge, a master incident number, an escalation level, a service name, an issuer control number, customer management, configuration management, and the like. Further, the customer management includes a contract number, a system ID, a corporate name, a department name, and the like. The configuration management includes a master type, a tenant ID, VSYS ID, a host name, an OS, a software name, and the like. The information described here is an example of registration information as an incident, and the setting can be arbitrarily changed.

Then, when the retrieval execution unit 16 detects a character input to any item, using the script, in an ON state of the simple retrieval, where the icon A of the simple retrieval is in ON display, the retrieval execution unit 16 issues the retrieval query with the input character string as a keyword to the incident DB server 50. For example, in a case where an “error” is input to the point of reception, the retrieval execution unit 16 issues “point of reception: error” as the retrieval query.

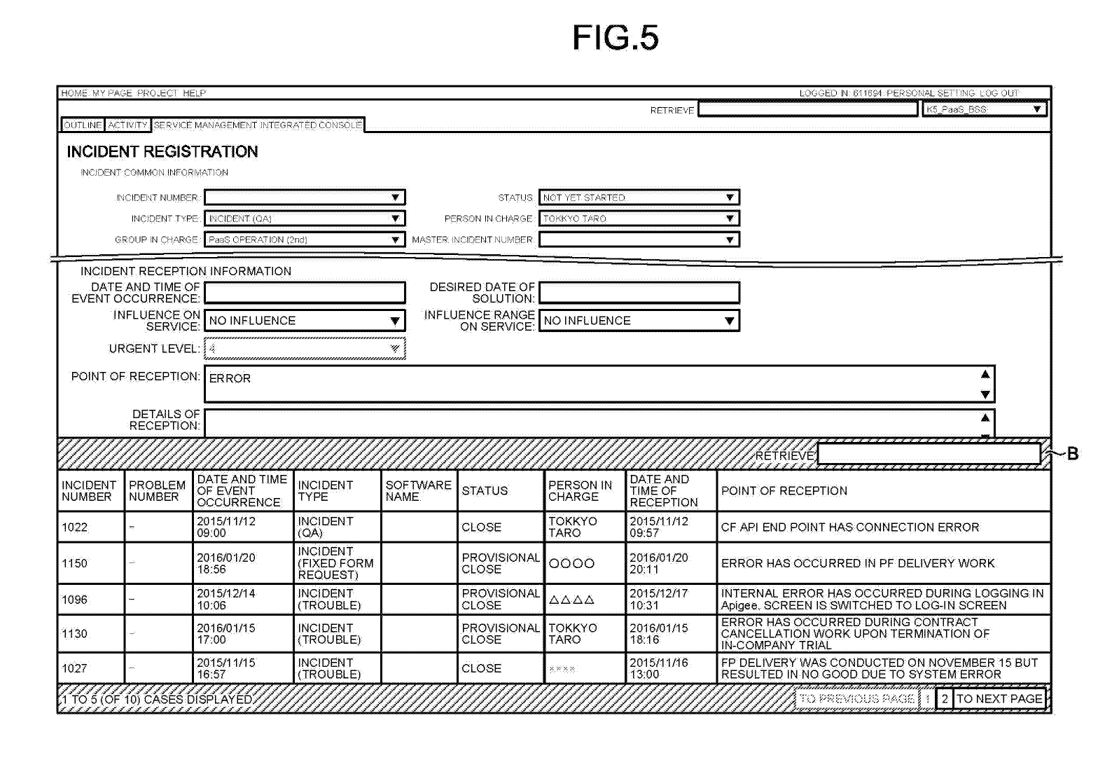

FIG. 5 is a diagram illustrating an example of a screen of incident retrieval results. As illustrated in FIG. 5, a retrieval result screen B of the incident retrieval results is superimposed and displayed on the incident registration screen. Information displayed as the retrieval results may be the incidents registered to the incident DB server 50 as it is, or may be a screen obtained by editing the retrieval results for the screen. Further, FIG. 5 illustrates an example of displaying the retrieval result screen B right under the “point of reception” in which “error” has been input on the incident registration screen. However, the place to display the information is not limited to the example, and the setting can be arbitrarily changed.

As described above, when the character string is input to the inputting item on the incident registration screen in the ON state of the simple retrieval, in which the icon A of the simple retrieval is in ON display, the retrieval execution unit 16 automatically executes the retrieval, and automatically displays the retrieval results. Here, the retrieval execution unit 16 has some conditions in performing the automatic retrieval.

For example, in a case where no operation continues for a predetermined time (for example, 1.5 seconds) from when the character string is input to the inputting item, the retrieval execution unit 16 executes the automatic retrieval. In doing so, a user (manager) can execute the incident retrieval without feeling stress.

Further, when the retrieval execution unit 16 detects inputs to a plurality of the inputting items, the retrieval execution unit 16 gives a higher priority to a last input character string. For example, assume that the retrieval execution unit 16 detects the input of the “error” to the point of reception within 1.5 seconds after detecting an input of “Tokkyo Taro” to the name of a person in charge. In this case, the retrieval execution unit 16 issues “name of a person in charge: Tokkyo Taro” and “point of reception: error” as the retrieval queries. At this time, the retrieval execution unit 16 sends information indicating which item is input later together with the retrieval queries, or sends the lase-input item first or last. After that, the retrieval execution unit 16 displays the retrieval results such that the incidents including the last-input “error” come to upper rows in the retrieval results.

Further, in a case where the character string is input to the inputting item by transcription by a right click described below, the retrieval execution unit 16 restrains the automatic retrieval. That is, when the retrieval execution unit 16 detects the character input by a right click processing unit 22, the retrieval execution unit 16 does not issue the retrieval query, and does not execute update of the retrieval screen. However, in a case where an increase/decrease in the characters occurs in the character string input by the right click processing unit 22, the retrieval execution unit 16 executes the automatic retrieval.

Note that the input of the character string and the increase/decrease in the character string are executed using the script, the execution environment of which is mounted on the Web browser. Further, as described above, there are the conditions of the automatic retrieval for the input characters. However, when the increase/decrease in the characters is detected, the automatic retrieval is executed.

Referring back to FIG. 3, the modal display unit 17 is a processing unit that displays the modal on the incident registration screen. To be specific, the modal display unit 17 displays, on the modal, the mouse-over incident on the retrieval result screen B of the incident retrieval results.

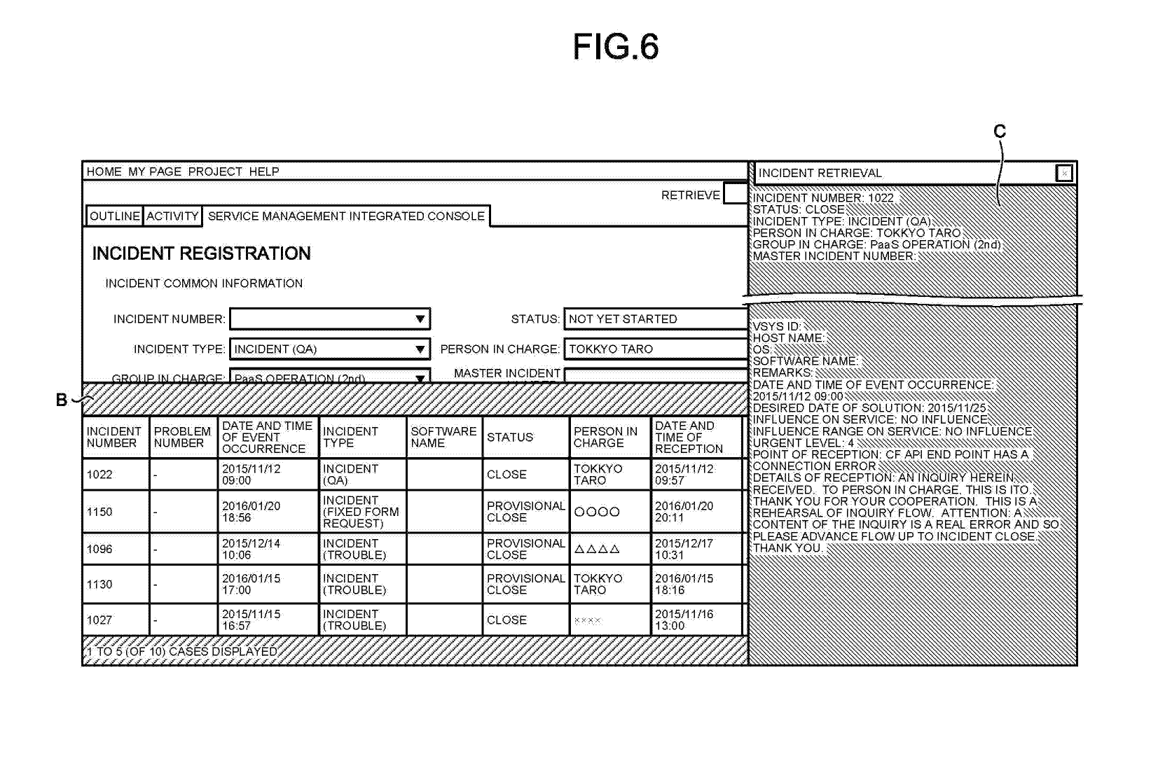

FIG. 6 is a diagram illustrating an example of a screen of modal display. As illustrated in FIG. 6, the modal display unit 17 displays, when an incident number “1022” on the retrieval result screen B is mouse-over, information of the incident registered as the incident number “1022” on a modal C. The information displayed on the modal C is information obtained by editing the information registered as the incident in a hypertext markup language (HTML) format. Further, items on the modal C are exactly matched with the items on the incident registration screen.

That is, the items including “an incident number, a status, an incident type, a name of a person in charge, . . . ” displayed on the modal C are the items existing on the incident registration screen. Note that the display area of the modal C illustrated in FIG. 6 is an example, and the setting can be arbitrarily changed.

The registration unit 20 is a processing unit that includes the left click processing unit 21, the right click processing unit 22, an editing unit 23, and a registration execution unit 24, and registers the incident to the incident DB server 50.

The left click processing unit 21 is a processing unit that executes copy to the clipboard 12 when detecting a left click, using the script. To be specific, when the left click processing unit 21 detects the left click on the modal C, the left click processing unit 21 copies the character string written in a place where the left click has been detected, to the clipboard 12.

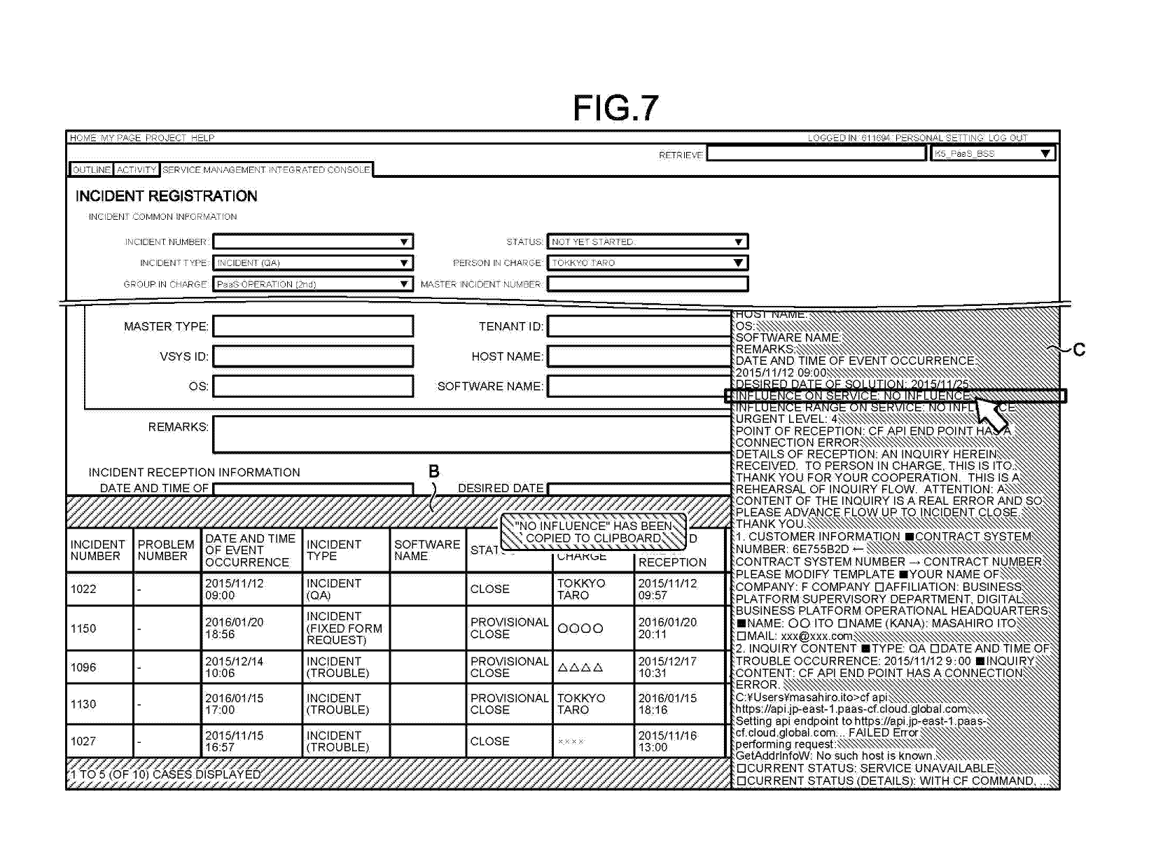

FIG. 7 is a diagram illustrating an example of an operation at the time of the left click. The screen illustrated in FIG. 7 indicates a state in which the retrieval result screen B and the modal C are displayed on the incident registration screen. In this state, when the left click processing unit 21 detects the left click on the modal C, the left click processing unit 21 identifies a tag of HTML in the position where the left click has been detected, and extracts an item name “influence on service” and a character string “no influence” specified by the tag. Then, the left click processing unit 21 copies the character string “no influence” and stores the character string to the clipboard 12. At this time, the left click processing unit 21 displays a message indicating that the copy has been made on the incident registration screen.

Note that the detection of the left click, and detection of the left-clicked position and the tag can be performed using functions of the script. However, an embodiment is not limited thereto, and various known technique can be employed.

The right click processing unit 22 is a processing unit that performs transcription to an appropriate item on the incident registration screen without performing copy to the clipboard 12 when detecting the right click, using the script. To be specific, when the right click processing unit 22 detects the right click on the modal C, the right click processing unit 22 holds the character string written in the place where the right click has been detected as a variable of the script. Then, the right click processing unit 22 transcribes the character string held as the variable of the script to the same item as the item right-clicked on the modal C, of the items on the incident registration screen.

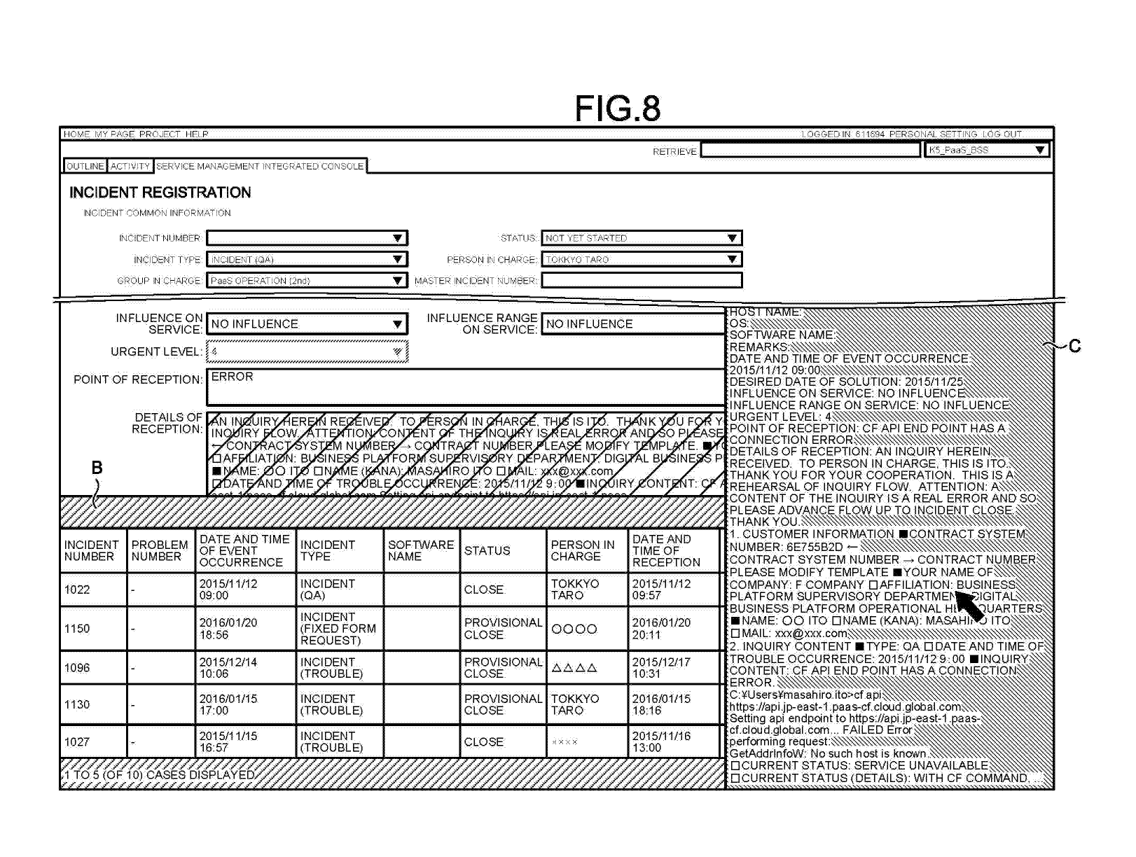

FIG. 8 is a diagram illustrating an example of an operation at the time of the right click. The screen illustrated in FIG. 8 indicates a state in which the retrieval result screen B and the modal C are displayed on the incident registration screen. In this state, when the right click processing unit 22 detects the right click on the modal C, the right click processing unit 22 identifies a tag of HTML in the position where the right click has been detected, and extracts an item name “details of reception” and a character string “an inquiry has been herein received. To the person in charge, this is Ito. Thank you for your cooperation. The inquiry is . . . (omission)” specified by the tag. Then, the right click processing unit 22 holds the character string “an inquiry has been herein received. To the person in charge, this is Ito. Thank you for your cooperation. The inquiry is . . . (omission)” as a variable of the script.

Next, the right click processing unit 22 identifies the extracted item name “details of reception” from the items on the registration screen of the incident, and transcribes the character string “an inquiry has been herein received. To the person in charge, this is Ito. Thank you for your cooperation. The inquiry is . . . (omission)” held as the variable of the script to the identified item name “details of reception”. In a case where the character string is transcribed by the right click processing unit 22, the retrieval processing is not executed.

Note that the retrieval processing may be performed for the character string pasted from the clipboard 12. For example, the retrieval execution unit 16 can determine that the input is made by paste when the input character string and the character string held on the clipboard 12 are matched.

The detection of the right click, and detection of the right-clicked position and the tag can be performed using functions of the script. However, an embodiment is not limited thereto, and various known technique can be employed.

The editing unit 23 is a processing unit that executes an input and deletion of the character string to the registration screen of the incident. To be specific, the editing unit 23 receives inputs to the items on the registration screen of the incident. When the character string and the like have been received, the retrieval execution unit 16 sets the input character string and the like as the retrieval keywords, and executes the retrieval processing.

Further, the editing unit 23 detects an increase/decrease in the already input character string, the character string pasted from the clipboard 12, and the character string transcribed by the right click processing unit 22. When the increase/decrease in the character string, the retrieval execution unit 16 sets the increased/decreased character string as the retrieval keyword, and issues the retrieval query.

The registration execution unit 24 is a processing unit that executes the registration of the incident. To be specific, when pressing of a “registration button” on the incident registration screen or the like is executed, the registration execution unit 24 issues the registration query including the information input on the incident registration screen at that time to the incident DB server 50.

Functional Configuration of Incident DB server 50

As illustrated in FIG. 3, the incident DB server 50 includes a communication control unit 51, an incident DB 52a, a retrieval setting DB 52b, and a control unit 53.

The communication control unit 51 is a processing unit that controls communication between the own server and other devices such as the terminal device 10, and is, for example, a network interface card. For example, the communication control unit 51 executes control regarding the Web browser between the own server and the terminal device 10. Further, the communication control unit 51 receives the retrieval query and the registration query from the terminal device 10, and transmits the retrieval results and various replies to the terminal device 10.

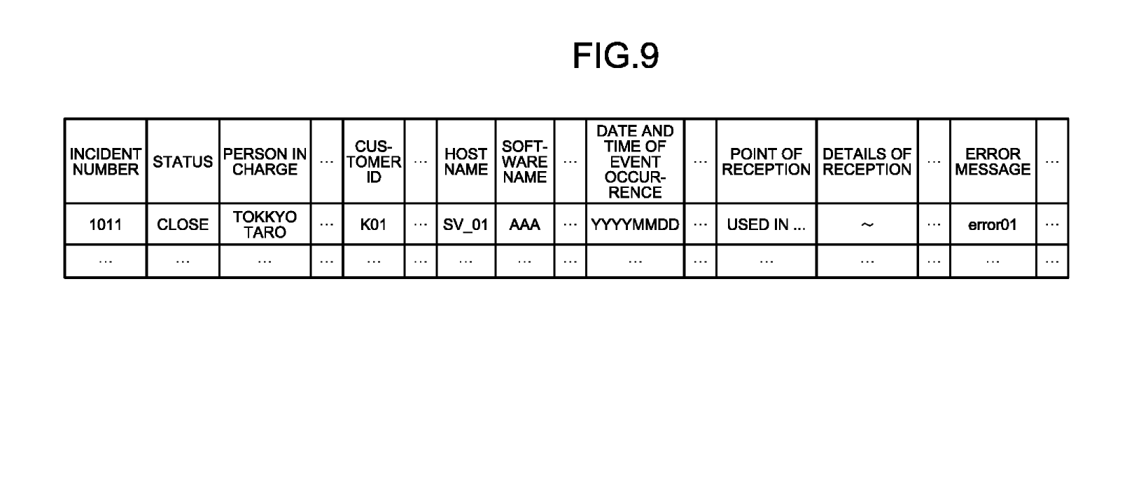

The incident DB 52a is a database that stores the incident registered by the terminal device 10, and is stored in a memory or a hard disk, for example. FIG. 9 is a diagram illustrating an example of information stored in the incident DB 52a. As illustrated in FIG. 9, the incident DB 52a stores “an incident number, a status, a name of a person in charge, . . . , a customer ID, . . . , a host name, a software name, . . . , date and time of occurrence of event, . . . , a point of reception, details of reception, an error message, . . . , and the like”.

The “incident number” stored here is an identifier that identifies the incident, and is uniquely allocated. The “status” is a state of the inquiry (incident), and ‘close’ indicating that the problem has been solved, ‘provisional close” indicating that the response has been made, and the like are set. The “name of a person in charge” is a name of a person in charge who has registered the incident, the “customer ID” is an identifier of a customer for whom an event has occurred, the “host name” is a name of the server (host) in which an event has occurred, and the “software name” is a name of software in which an event has occurred. The “date and time of occurrence of event” is date and time when an event has occurred, the “point of reception” is a point of content of the inquiry (event), the “details of reception” is details of the content of the inquiry (event), and the “error message” is an error message detected in the system at the time of occurrence of an event.

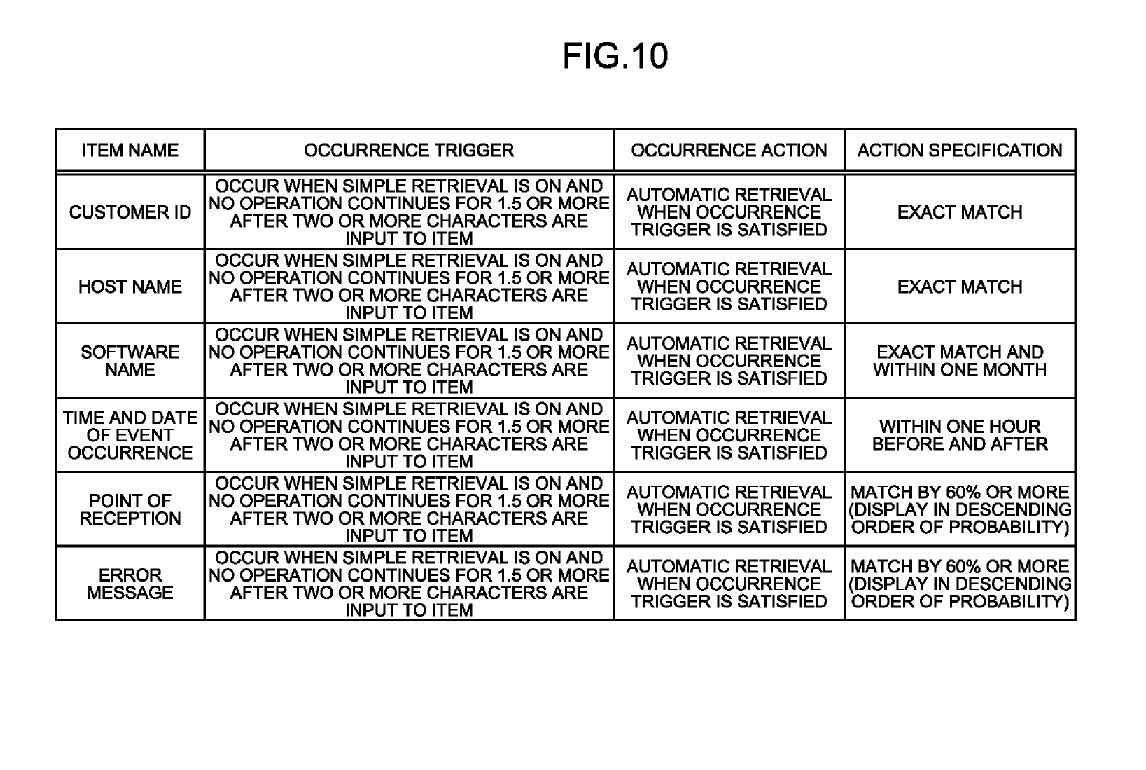

The retrieval setting DB 52b is a database that stores a retrieval condition set to each inputting item, and is stored in a memory or a hard disk, for example. FIG. 10 is a diagram illustrating an example of information stored in the retrieval setting DB 52b.

As illustrated in FIG. 10, the retrieval setting DB 52b stores “an item name, occurrence trigger, an occurrence action, and an action specification” in association with one another. The “item name” stored here is an item name included in the retrieval query, and is an item name to which the character string is input on the incident registration screen. The “occurrence trigger” is a condition in which the retrieval processing is executed, and is set to the terminal device 10 side in the present embodiment. Further, the “occurrence trigger” is a condition in which the retrieval query is issued. The “occurrence action” is retrieval processing executed when the occurrence trigger is satisfied, and is set to the terminal device 10 side in the present embodiment. As the “occurrence action”, specific action content of the retrieval processing is set.

In the example of FIG. 10, in a case where the retrieval query automatically issued by the terminal device 10 includes the “customer ID” when a condition that “the simple retrieval is ON, and no action continues for 1.5 (seconds) or more after two or more characters are input to the item” is satisfied, this case indicates that the incident including the character string exactly matched with the “character string (keyword)” included in the retrieval query is retrieved from the incident DB 52a.

Further, in a case where the retrieval query automatically issued by the terminal device 10 includes the “software name” when the condition that “the simple retrieval is ON, and no action continues for 1.5 (seconds) or more after two or more characters are input to the item” is satisfied, the case indicates that the incidents registered within one month from a retrieval date and time (current date and time), of the incidents including the character string exactly matched with the “character string (keyword)” included in the retrieval query, are retrieved from the incident DB 52a.

Further, in a case where the retrieval query automatically issued by the terminal device 10 includes the “date and time of occurrence of event” when the condition that “the simple retrieval is ON, and no action continues for 1.5 (seconds) or more after two or more characters are input to the item” is satisfied, the case indicates that the incidents of the event occurring within one hour before and after the time indicated by the “character string (keyword)” included in the retrieval query are retrieved from the incident DB 52a.

Further, in a case where the retrieval query automatically issued by the terminal device 10 includes the “point of reception” when the condition that “the simple retrieval is ON, and no action continues for 1.5 (seconds) or more after two or more characters are input to the item” is satisfied, the case indicates that the incidents including characters matched with the “character string (keyword)” included in the retrieval query by 60% or more are retrieved from the incident DB 52a. At this time, the retrieval result is displayed such that the incident having a higher probability is displayed to a higher rank.

The control unit 53 is a processing unit that controls processing of the entire incident DB server 50, and is, for example, a processor. The control unit 53 includes a retrieval query execution unit 54 and a registration query execution unit 55. Note that the retrieval query execution unit 54 and the registration query execution unit 55 are examples of electronic circuits included in the processor or examples of processes executed by the processor.

The retrieval query execution unit 54 is a processing unit that executes the retrieval query. To be specific, when the retrieval query execution unit 54 receives the retrieval query from the terminal device 10, the retrieval query execution unit 54 extracts the item name included in the retrieval query, and identifies the action specification from the retrieval setting DB 52b. Then, the retrieval query execution unit 54 retrieves the incident that satisfies the identified action specification from the incident DB 52a, using the “character string” included in the retrieval query as the keyword. After that, the retrieval query execution unit 54 replies to the terminal device 10 with the retrieval result.

For example, in a case where the retrieval query execution unit 54 receives the retrieval query “host name: SV01”, the retrieval query execution unit 54 identifies the action specification “exact match” corresponding to the item name “host name”. Then, the retrieval query execution unit 54 retrieves the registration information of all the items about the incidents stored in the incident DB 52a, and retrieves the incident having the “SV01” registered in any of the items. That is, the retrieval query execution unit 54 executes full text retrieval for the information registered to the incident, and retrieves the incident in which the “SV01” is registered. After that, the retrieval query execution unit 54 replies to the terminal device 10 with the retrieval result.

Further, in a case where the retrieval query execution unit 54 receives the retrieval query “software name: SW01”, the retrieval query execution unit 54 identifies the action specification “exact match and within one month” corresponding to the item name “software name”. Then, the retrieval query execution unit 54 extracts the incidents within one month from the current date (or date and time), from the incidents stored in the incident DB 52a. Next, the retrieval query execution unit 54 executes the full text retrieval for the extracted incidents, and retrieves the incident having the “SW01” registered to any of the items. After that, the retrieval query execution unit 54 replies to the terminal device 10 with the retrieval result.

Further, in a case where the retrieval query execution unit 54 receives the retrieval query “date and time of occurrence of event: 9:00, Mar. 16, 2016”, the retrieval query execution unit 54 identifies the action specification “within one hour before and after” corresponding to the item name “date and time of occurrence of event”. Then, the retrieval query execution unit 54 retrieves the incidents having the date and time of occurrence of event falling under “8:00, Mar. 16, 2016” to “10:00, Mar. 16, 2016”, from the incidents stored in the incident DB 52a. After that, the retrieval query execution unit 54 replies to the terminal device 10 with the retrieval results.

Further, when the retrieval query execution unit 54 receives the retrieval query “point of reception: an error has been detected in oo system. Tokkyo Taro made response in the past. I would like to check similar content”, the retrieval query execution unit 54 identifies the action specification “matched by 60% or more (displayed in descending order of probability) corresponding to the item name “point of reception”. Then, the retrieval query execution unit 54 retrieves the registration information of all the items about the incidents stored in the incident DB 52a, and extracts the incident including the characters of “an error has been detected in oo system. Tokkyo Taro made a response in the past. I would like to check similar content” by 60% or more. After that, the retrieval query execution unit 54 rearranges the retrieval results such that the incident having a high probability is displayed on a priority basis, and replies to the terminal device 10.

Note that, in a case where the retrieval query execution unit 54 receives a plurality of the retrieval queries, the retrieval query execution unit 54 retrieves the keywords under OR conditions. For example, when the retrieval query execution unit 54 receives the retrieval query “software name: SW01” and “host name: SV01”, the retrieval query execution unit 54 retrieves the incidents including “SW01” or “SV01”. Then, the retrieval query execution unit 54 rearranges the retrieval results such that the last input item, in other words, the retrieval result for the latest input item is displayed on a priority basis, and replies to the terminal device 10.

The registration query execution unit 55 is a processing unit that executes the registration query. To be specific, when the registration query execution unit 55 receives the registration query from the terminal device 10, the registration query execution unit 55 acquires the incident information included in the registration query and the incident information input to the Web browser, and assigns the incident numbers the information and registers the information to the incident DB 52a.

Specific Example

Next, processing by the left click and processing by the right click will be described using a specific example. Note that, here, simplified information from which the information displayed on the incident registration screen and on the modal is omitted will be exemplarily described. For example, assume that “the customer ID, the host name, the software name, and the point of reception” as the inputting items, and the modal C are displayed on the incident registration screen. Further, assume that “the customer ID: K01, the host name: SV01, the software name: SW01, and the point of reception: an error has occurred ˜˜˜” are displayed on the modal C.

Description of Click Operation

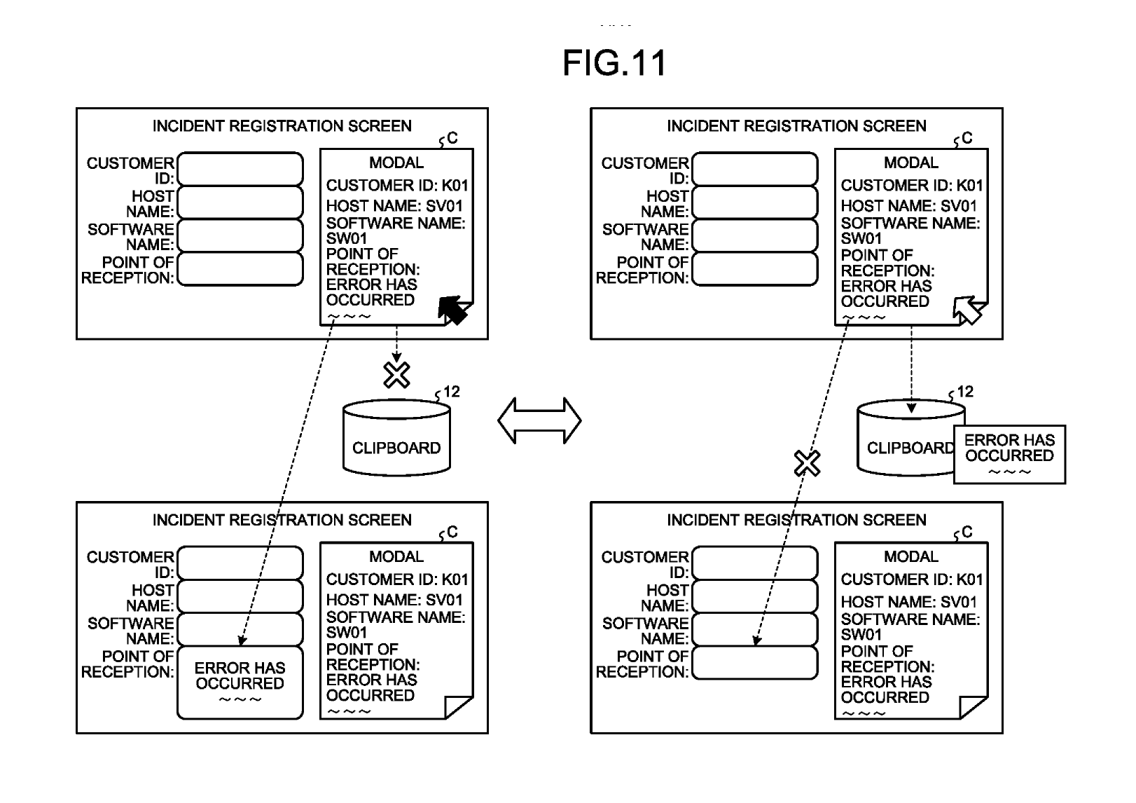

FIG. 11 is a diagram for describing a click operation. The left diagram of FIG. 11 is a diagram for describing an operation at the time of the right click. As illustrated in the left diagram of FIG. 11, when the right click processing unit 22 detects the right click on the “point of reception: an error has occurred ˜˜˜” on the modal C, the right click processing unit 22 transcribes the “error has occurred ˜˜˜” to the “point of reception” that is the same item on the incident registration screen without executing copy to the clipboard 12.

Meanwhile, the right diagram of FIG. 11 is a diagram for describing an operation at the time of the left click. As illustrated in the right diagram of FIG. 11, when the left click processing unit 21 detects the left click on the “point of reception: an error has occurred ˜˜˜” on the modal C, the left click processing unit 21 copies the “error has occurred ˜˜˜” to the clipboard 12, but does not execute transcription to the “point of reception” that is the same item on the incident registration screen.

Trigger of Retrieval Processing

In the above description, a specific technique to input the character string to the incident registration screen has been described. However, in reality, when a character string that satisfies a predetermined condition is input, the retrieval result screen B is automatically uprated. That is, when an input that satisfies a predetermined condition has occurred, the automatic retrieval is executed. Therefore, here, the retrieval processing will be described. Note that “determination as to whether no operation continues for 1.5 seconds or more” included in the predetermined condition is omitted.

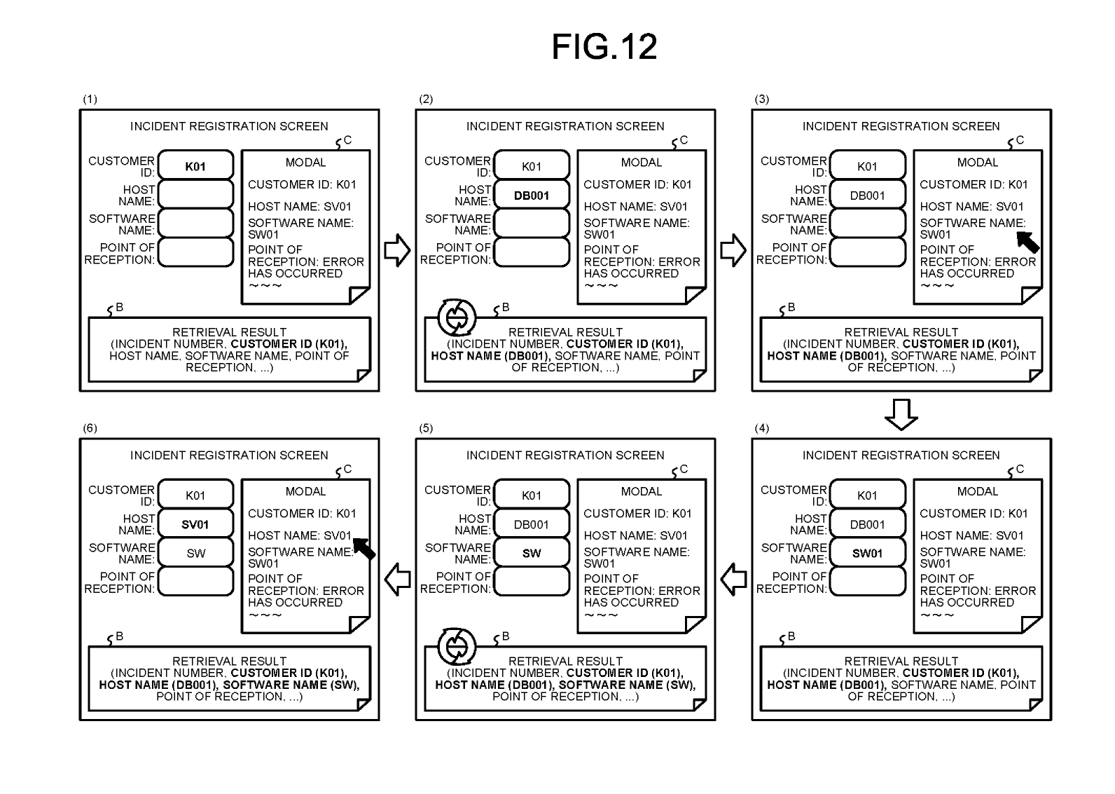

FIG. 12 is a diagram for describing execution trigger of the retrieval processing. As illustrated in (1) of FIG. 12, when the retrieval execution unit 16 of the terminal device 10 detects an input (manual input) of “K01” to the customer ID on the incident registration screen, the retrieval execution unit 16 issues the retrieval query of the “customer ID: K01” to the incident DB server 50.

The retrieval query execution unit 54 of the incident DB server 50, which has received the retrieval query, retrieves the incident including the character string exactly matched with the “K01” from the incident DB 52a, and replies to the terminal device 10 with the retrieval result. Then, the terminal device 10 displays the retrieval result on the retrieval result screen B.

Next, as illustrated in (2) of FIG. 12, when the retrieval execution unit 16 of the terminal device 10 detects an input (manual input) of “DB001” to the host name on the incident registration screen, the retrieval execution unit 16 issues the retrieval query including the “customer ID: K01” and the “host name: DB001” to the incident DB server 50.

The retrieval query execution unit 54 of the incident DB server 50 that has received the retrieval query retrieves the incidents including the character string exactly matched with the “K01” or the “DB001” from the incident DB 52a. Then, the retrieval query execution unit 54 rearranges the retrieval results such that the incident including the “DB001” that is the last input is displayed in a higher rank, and replies to the terminal device 10. After that, the terminal device 10 displays the retrieval results on the retrieval result screen B.

Next, as illustrated in (3) of FIG. 12, when the right click processing unit 22 of the terminal device 10 detects the right click on the “software name: SW01” on the modal C, the right click processing unit 22 transcribes the “SW01” to the “software name” on the incident registration screen without performing copy to the clipboard 12. At this time, as illustrated in (4) of FIG. 12, the retrieval execution unit 16 determines that the input operation is the transcription by the right click, and restrains issuance of the retrieval query. As a result, the retrieval result screen B is unchanged from (3) of FIG. 12 although the new character string has been input to the incident registration screen.

Here, as a technique of the retrieval execution unit 16 of the terminal device 10 to determine whether the input character string is made by transcription, various types of processing can be employed. For example, the retrieval execution unit 16 can determine that the input is made by transcription when the input character string and the character string held as a variable of the script are matched. Further, the retrieval execution unit 16 of the terminal device 10 can determine that the input is made by transcription when the input is made without character conversion and the like.

Then, the retrieval execution unit 16 of the terminal device 10 detects that the “SW01” transcribed by the right click is changed to “SW”, for the software name on the incident registration screen, as illustrated in (5) of FIG. 12. That is, the retrieval execution unit 16 detects that the transcribed character string has been edited. Then, the retrieval execution unit 16 generates a new retrieval query “software name: “SW”, in addition to the retrieval query “customer ID: K01” and “host name: DB001” so far, and issues a retrieval query including these three.

The retrieval query execution unit 54 of the incident DB server 50, which has received the retrieval query, retrieves the incidents including the character string exactly matched with any of the “K01”, the “DB001”, and the “SW” from the incident DB 52a. Then, the retrieval query execution unit 54 rearranges the retrieval results such that the incidents are displayed in higher ranks in a newly input order of the “SW”, the “DB001”, and the “K01”, and replies to the terminal device 10. After that, the terminal device 10 displays the retrieval results on the retrieval result screen B.

Next, as illustrated in (6) of FIG. 12, when the right click processing unit 22 of the terminal device 10 detects the right click on the “host name: SV01” on the modal C, the right click processing unit 22 transcribes the “SV01” to the “host name” on the incident registration screen without performing copy to the clipboard 12. At this time, the retrieval execution unit 16 determines that the input operation is the transcription by the right click, and restrains issuance of the retrieval query. As a result, the retrieval result screen B is unchanged from (5) of FIG. 12 although the new character string has been input to the incident registration screen.

Flows of Processing

Next, flows of the above-described processing will be described. Here, the retrieval processing of the terminal device 10, and the retrieval processing of the incident DB server 50 will be described.

Retrieval Processing of Terminal Device 10

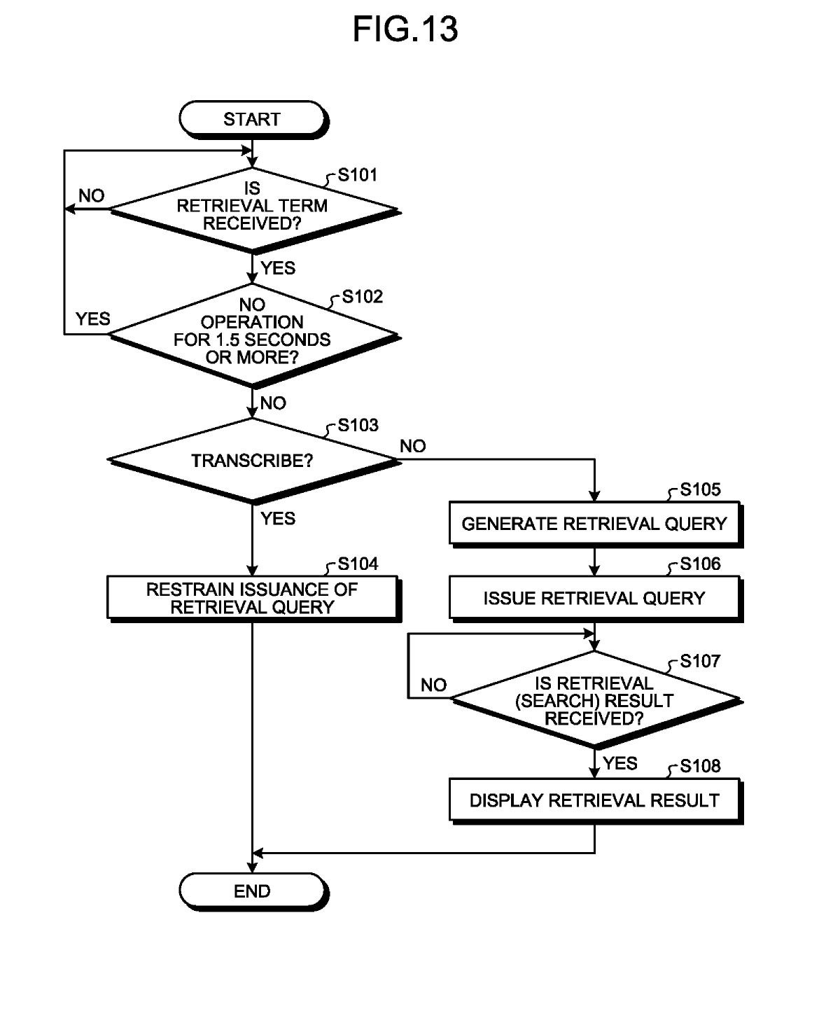

FIG. 13 is a flowchart illustrating a flow of the retrieval processing of the terminal device 10. When the retrieval execution unit 16 of the terminal device 10 receives an input of the character string (retrieval term) including an increase/decrease in the number of characters and a new input on the incident registration screen (Yes in S101), the retrieval execution unit 16 determines whether no operation continues for 1.5 seconds or more (S102).

Then, when the retrieval execution unit 16 detects a new operation (input) within 1.5 seconds (Yes in S102), the retrieval execution unit 16 repeats S101 and subsequent steps. On the other hand, when no operation continues for 1.5 seconds or more (No in S102), the retrieval execution unit 16 determines whether the input operation is the transcription by the right click (S103).

Then, when the input operation is the transcription by the right click (Yes in S103), the retrieval execution unit 16 restrains issuance of the retrieval query (S104).

On the other hand, when the input operation is not the transcription by the right click (No in S103), the retrieval execution unit 16 generates the retrieval query including the input item name and the character string (S105), and issues the retrieval query to the incident DB server 50 (S106).

After that, when the retrieval execution unit 16 receives the retrieval result from the incident DB server 50 (Yes in S107), the retrieval execution unit 16 displays the retrieval result (S108).

Retrieval Processing of Incident DB server 50

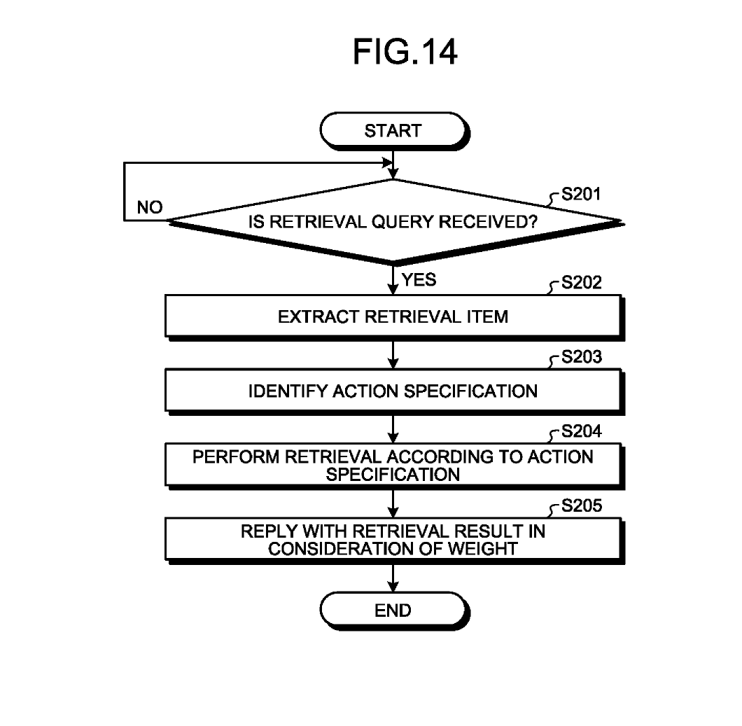

FIG. 14 is a flowchart illustrating a flow of the retrieval processing of the incident DB server 50. When the retrieval query execution unit 54 of the incident DB server 50 receives the retrieval query from the terminal device 10 (Yes in S201), the retrieval query execution unit 54 extracts the item from the retrieval query (S202), and identifies the action specification by reference to the retrieval setting DB 52b (S203).

After that, the retrieval query execution unit 54 executes the full text retrieval of the registered incident according to the identified action specification (S204), and replies to the terminal device 10 with the retrieval result (S205).

Effect

As described above, the incident management system prepares a table that defines the range of extended retrieval for each of the inputting items of the incident in advance, and can perform retrieval from the incident DB server 50 that executes a full text retrieval algorithm on the basis of the action specification that defines input content and content of the extended range. Therefore, the manager can set the retrieval keyword according to an own understanding state in a case where the manager knows an event to be retrieved in advance, or roughly knows the event to be retrieved.

For example, in a case where the manager wants to check whether a certain incident occurred in a target server “appser01” in the past, the manager designates the “appser01” in the item name “host name” in which “action specification=exact match” is defined, and performs the incident retrieval. In doing so, the manager can retrieve only the incidents focusing on the “appser01”, and can efficiency narrow down the incidents to refer.

Meanwhile, in a case where the manager wants to know whether the certain incident occurred not only in the target sever “appser01” but also in similar servers, the manager designates the “appser01” in the item name “point of reception” in which “action specification=matched by 60% or more” is defined, and performs the incident retrieval. In doing so, the manager can retrieve the incidents focusing not only on the “appser01”, but also on “appser02” and “appser03” similar to the “appser01” by 60% or more. Therefore, the manager can efficiently retrieve related incidents when performing registration of a certain incident.

Further, the incident DB server 50 can perform retrieval, covering one hour before and after an event occurrence time. Therefore, overlapping registration and the like can be restrained even when inquiries or failures to be registered to incidents excessively occur, and reliability of the database can be improved.

Typically, the incident once issued in the incident DB 52a is not able to be deleted ex-post facto, and registration is often performed after the database is retrieved. Further, timing of the registration is left to the discretion of the person in charge, and thus inquiries of the same event frequently occur, and a plurality of the persons in charge may make a response.

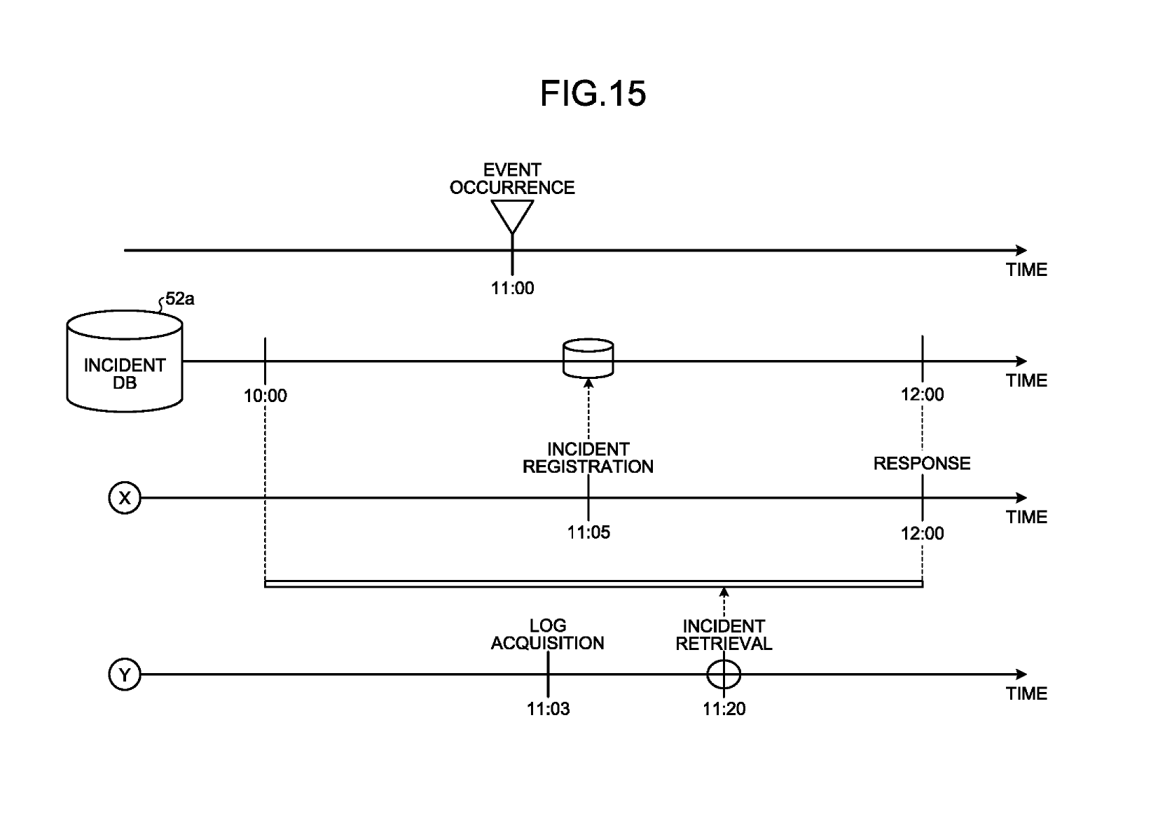

FIG. 15 is a diagram for describing a retrieval range. As illustrated in FIG. 15, an event occurs at 11:00, and an error or the like may be detected in the terminal device 10 of a person in charge Y in parallel with a customer making an inquiry to a person in charge X about this event.

To be specific, after detecting the error in the system, the person in charge Y acquires an error log at “11:03” before registration of the incident. Meanwhile, the person in charge X performs incident registration at “11:05” immediately after receiving the inquiry, and then makes a response to the inquiry at “12:00”.

Further, the person in charge Y executes retrieval of already registered incidents, in performing incident registration at “11:20” after acquisition of the error log. At this time, the incident DB server 50 retrieves the incidents, using, as the extended range of the retrieval, “10:00 to 12:00” that is one hour before and after the “11:00” that is the event occurrence time.

As a result, the person in charge Y can refer to the incident for the same event and registered by the person in charge X. Therefore, the person in charge Y can restrain overlapping registration of the incident for the same event. Further, by allocating the above-described example to the similarity retrieval, the manager can retrieve the most recent similar incidents, and thus can perform registration while referring to the latest incidents. Therefore, freshness and reliability of the information registered as the incident can be maintained at a high level.

### [b] Second Embodiment

An embodiment of the present invention has been described. However, the present invention may be implemented in various different forms other than the above-described embodiment.

Script

The script described in the above-described embodiment is an example, and an embodiment is not limited to the example. For example, other technologies that allow an execution environment to be incorporated in a Web browser or the like can be employed. A Web browser including an execution environment of a script having a similar function to the above-described script can be operated on the present system. Further, various known algorithms can be employed as an algorithm of full text retrieval.

Object to be Transcribed/Copied

In the above-described embodiment, a character string has been used as the object to be transcribed or copied. However, an embodiment is not limited thereto. For example, data such as characters, images, and sounds can be similarly processed. Further, in the above-described embodiment, an example in which the right click corresponds to the transcription and the left click corresponds to the copy has been described. However, an embodiment is not limited to the example, and the right click may correspond to the copy and the left click may correspond to the transcription.

Action Definition

The action specifications described in the above embodiment are examples, and are not limited to the described examples. For example, setting of the action specification can be arbitrarily changed to “exact match of first two letters”, “exact match by the same item name, or match by 60% or more in full text retrieval”, or the like. Further, setting of association between the item name and the action specification can be arbitrarily changed.

Further, in the above embodiment, an example in which the incident DB server 50 identifies the action specification has been described. However, an embodiment is not limited to the example. A terminal device 10 side can identify an action specification. For example, the terminal device 10 holds a database illustrated in FIG. 10, sets, to a retrieval query, a parameter that identifies the action specification, and issues the retrieval query to an incident DB server 50. The incident DB server 50 identifies the action specification from the received retrieval query, and executes retrieval according to the identified action specification. In doing so, each manager can set the action specification according to his/her habit. Therefore, the system becomes more convenient.

Time Setting

In the above embodiment, an example in which the incidents occurring within one hour before and after the event occurrence time are retrieved using the event occurrence time as a reference time has been described. However, an embodiment is not limited to the example. For example, incidents occurring within one hour before and after a time set by a manager can be retrieved using the time as the reference time. That is, the reference time can be set by the manager.

Another Example of Retrieval Trigger

In the above embodiment, an example in which the retrieval result is updated when the character string is input to the inputting item or when an increase/decrease in the character string occurs has been described. However, an embodiment is not limited to the example. For example, a retrieval result can be updated when an incident stored in an incident DB 52a of an incident DB server 50 is updated. In more detail, the incident DB server 50 holds a retrieval query for each terminal device 10, automatically performs re-retrieval when a new incident is added to the DB, and replies with the retrieval result. In doing so, the manager can easily retrieve the latest incident even during reference to incidents.

System

Further, the configurations of the devices illustrated in FIG. 3 are not always physically configured as illustrated in the drawings. That is, the configurations can be distributed or integrated in arbitrary units. For example, the retrieval execution unit 16 and the registration unit 20 can be integrated. Further, all or an arbitrary part of the processing functions performed in the devices can be realized by a central processing unit (CPU) and programs analyzed and executed by the CPU, or can be realized as hardware by a wired logic.

Further, all or a part of the processing described as those automatically performed, of the processing described in the present embodiment, can be manually performed. Further, all or a part of the processing described as those manually performed can be automatically performed by known methods. In addition, the information including the processing procedures, control procedures, specific names, and various data and parameters described and illustrated in the above texts and drawings can be arbitrarily changed unless otherwise specified.

Hardware

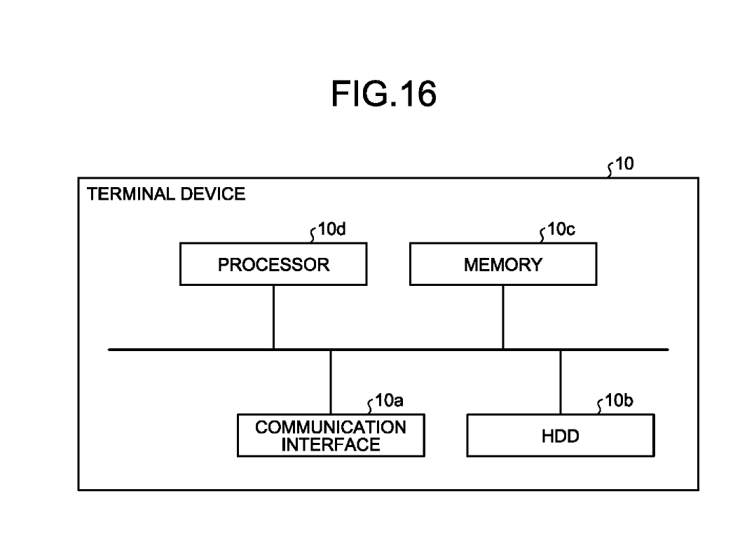

The terminal device 10 and the incident DB server 50 described above can be realized by a computer having a hardware configuration as follows, for example. Note that, here, the terminal device 10 is exemplarily described. However, the same applies to the incident DB server 50. FIG. 16 is a diagram for describing an example of a hardware configuration. As illustrated in FIG. 16, the terminal device 10 includes a communication interface 10a, a hard disk drive (HDD) 10b, a memory 10c, and a processor 10d.

An example of the communication interface 10a includes a network interface card. The HDD 10b is a storage device that stores programs and data.

Examples of the memory 10c include a random access memory (RAM) such as a synchronous dynamic random access memory (SDRAM), a read only memory (ROM), and a flash memory. Examples of the processor 10d include a CPU, a digital signal processor (DSP), a field programmable gate array (FPGA), and a programmable logic device (PLD).

Further, the terminal device 10 is operated as an information processing apparatus that executes an input assistance method, by reading and executing a program. That is, the terminal device 10 executes a program that executes similar functions to an access unit 14, a retrieval unit 15, and a registration unit 20. As a result, the terminal device 10 can execute a process that executes similar functions to the access unit 14, the retrieval unit 15, and the registration unit 20. Note that the program referred in this another embodiment is not limited to be executed by the terminal device 10. For example, the present invention can be similarly applied to a case in which another computer or server executes the program and a case where the program is executed by other computer and server in cooperation with each other.

This program can be distributed through a network such as the Internet. Further, this program can be executed by being recorded on a computer-readable recording medium such as a hard disk, a flexible disk (FD), a CD-ROM, a magneto-optical disk (MO), or a digital versatile disc (DVD), and read by a computer from the recording medium.

According to the embodiments, a retrieval result referred in input work can be efficiently displayed.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An input assistance method comprising:
receiving, in an incident case including a plurality of items in operation management, an input to a specific item included in the plurality of items, using a processor; and
retrieving the incident case corresponding to the input in an extended range according to the specific item in response the received input, using the processor.

2. The input assistance method according to claim 1, wherein the retrieving includes retrieving the incident case, in a case where the specific item is a time, using specific ranges before and after the time as the extended range.

3. The input assistance method according to claim 1, wherein the retrieving includes updating a result of the retrieval according to accumulation of the incident case.

4. The input assistance method according to claim 1, wherein the retrieving includes retrieving the incident case, in a case where the specific item is a time related to an event, using specific ranges before and after the time as the extended range.

5. The input assistance method according to claim 1, wherein the retrieving includes retrieving the incident case corresponding to the input in a case where no operation continues for a predetermined period after the input to any of the plurality of items.

6. A non-transitory computer-readable recording medium having stored therein an input assistance program that causes a computer to execute a process comprising:
receiving, in an incident case including a plurality of items in operation management, an input to a specific item included in the plurality of items; and
retrieving the incident case corresponding to the input in an extended range according to the specific item in response the received input.

7. An input assistance device comprising:
a processor configured to:
receive, in an incident case including a plurality of items in operation management, an input of a specific item included in the plurality of items; and
retrieve the incident case corresponding to the input in an extended range according to the specific item in response to the received input.
